(19) United States
(12) Patent Application Publication
(10) Pub. No.: US 2025/0286390 A1
(43) Pub. Date: Sep. 11, 2025

(54) BATTERY MANAGEMENT SYSTEM

(71) Applicant: CPS Technology Holdings LLC, New York, NY (US)

(72) Inventors: Eric M. MICHIELUTTI, Menomonee Falls, WI (US); Mark D. GUNDERSON, Bristol, WI (US); Jeffrey Aaron HARRIS, Oak Creek, WI (US); Ronald J. DULLE, Mequon, WI (US)

(21) Appl. No.: 18/863,734

(22) PCT Filed: May 17, 2023
(86) PCT No.: PCT/US2023/022539

§ 371 Date: Nov. 7, 2024

Related U.S. Application Data
(60) Provisional application No. 63/342,933, filed on May 17, 2022.

(51) Int. Cl. H02J 7/00

(52) U.S. Cl. CPC H02J 7/00304; H02J 7/0031

(57) ABSTRACT

A relay of a battery management system (BMS) is described. The relay includes a bus connection point, a stack connection point, a primary solid state relay (SSR) electrically connected to the bus connection point and the stack connection point. The primary SSR includes a first measurement point usable by the BMS for determining a first SSR state and a secondary SSR electrically connected to the bus connection point and the stack connection point. The secondary SSR is connected in parallel to the primary SSR and includes a second measurement point usable by the BMS for determining a second SSR state.

### TECHNICAL FIELD

This disclosure relates to energy storage units such as batteries, and in particular to battery management systems.

### BACKGROUND

Batteries are an essential part of many devices, including motor vehicles. Motor vehicles are typically equipped with a single battery, e.g., a lead acid battery, used to both start the vehicle's motor as well as to power the other systems of the vehicle, e.g., charging system, operation while running, lighting, accessories, etc. Reliability and safety of batteries generally depends on the battery health, i.e., condition of the battery, which may be linked to the condition of battery components.

Conventional systems may not provide the ability to effectively diagnose and/or control battery components, e.g., relays, switches, transistors, etc. For example, some conventional systems that use relays for safety of the battery cannot provide effective diagnosis or control of the relays. In some cases, controllers that are configured to operate the relays fail without being detected by any other components, which may lead to unsafe conditions of the battery, vehicle, etc.

### SUMMARY

Some embodiments advantageously provide a method, apparatus, and system for a battery management, e.g., a battery management system (BMS).

According to one aspect, a relay of a battery management system (BMS) is described. The relay includes a bus connection point, a stack connection point, a primary solid state relay (SSR) electrically connected to the bus connection point and the stack connection point. The primary SSR includes a first measurement point usable by the BMS for determining a first SSR state and a secondary SSR electrically connected to the bus connection point and the stack connection point. The secondary SSR is connected in parallel to the primary SSR and includes a second measurement point usable by the BMS for determining a second SSR state.

In some embodiments, the primary SSR includes a first transistor and a second transistor. The first transistor has a first source and a first drain, and the second transistor has a second source and a second drain. The second transistor is connected in series to the first transistor. The first drain is electrically connected to the second drain. The first source is electrically connected to the stack connection point. The second source is electrically connected to the bus connection point.

In some other embodiments, one or more of the first measurement point is positioned between the first drain and the second drain, the first transistor includes a first control point arranged to receive a first control signal that triggers the first transistor to open or close, and the second transistor includes a second control point arranged to receive a second control signal that triggers the second transistor to open or close.

In some embodiments, the secondary SSR includes a third transistor and a fourth transistor. The third transistor has a third source and a third drain. The fourth transistor has a fourth source and a fourth drain and is connected in series to the third transistor. The third drain is electrically connected to the fourth drain. The third source is electrically connected to the stack connection point. The fourth source is electrically connected to the bus connection point.

In some other embodiments, one or more of the second measurement point is positioned between the third drain and the fourth drain, the third transistor includes a third control point arranged to receive a third control signal that triggers the third transistor to open or close, and the fourth transistor includes a fourth control point arranged to receive a fourth control signal that triggers the fourth transistor to open or close.

In some embodiments, the secondary SSR is arranged to supply power while the primary SSR is one of diagnosed and open.

In some other embodiments, the primary SSR is a first metal-oxide-semiconductor field-effect transistor (MOSFET) SSR and the secondary SSR is a second MOSFET SSR. According to another aspect, a battery management system (BMS) is described. The

BMS includes a solid state relay (SSR) and processing circuitry comprising a microcontroller unit (MCU). The processing circuitry is electrically connected to the SSR and configured to determine a failure mode associated with the MCU based on one or more parameters and cause the SSR, without MCU intervention, to perform one or more actions based on the failure mode.

In some embodiments, the processing circuitry further includes a cell monitor unit (CMU) electrically connectable to one or more battery cells and a power management integrated circuit (PMIC) in communication with the CMU. One or both of the CMU and PMIC are configured to cause the SSR to perform the one or more actions based on the failure mode.

In some other embodiments, the CMU is configured to determine one or more parameters associated with the one or more battery cells.

In some embodiments, the MCU is in communication with the CMU, and the MCU is configured to determine parameter thresholds associated with the one or more parameters and transmit the parameter thresholds to the CMU.

In some other embodiments, the CMU is configured to determine a fault indication and transmit the fault indication to the MCU and the PMIC to cause the MCU and the PMIC to enter an active mode of operation.

In some embodiments, the PMIC is configured to determine the failure mode associated with the MCU based on a watchdog process usable for monitoring one or more MCU processes.

In some other embodiments, the processing circuitry further includes a secondary current unit (SCU) configured to detect an overcurrent condition based on a predetermined hardware current threshold.

In some embodiments, the SCU is further configured to cause the SSR to perform one or more actions based on the detected overcurrent condition and the predetermined hardware current threshold.

In some other embodiments, the SSR relay comprises a bus connection point, a stack connection point, and a primary solid state relay (SSR) electrically connected to the bus connection point and the stack connection point. The primary SSR includes a first measurement point usable by the BMS for determining a first SSR state.

In some embodiments, the SSR relay further includes a secondary SSR electrically connected to the bus connection point and the stack connection point, where the secondary SSR is connected in parallel to the primary SSR and includes a second measurement point usable by the BMS for determining a second SSR state.

In some other embodiments, the one or more actions include one of disabling the SSR, enabling the SSR, opening the SSR, and closing the SSR.

According to an aspect, a battery is described. The battery includes one or more battery cells and a battery management system (BMS). The BMS is electrically connected to the one or more battery cells and includes a solid state relay (SSR) electrically connected to the one or more battery cells and processing circuitry including a microcontroller unit (MCU). The processing circuitry is electrically connected to the SSR and configured to determine a failure mode associated with the MCU based on one or more parameters and cause the SSR, without MCU intervention, to perform one or more actions based on the failure mode.

In some embodiments, the processing circuitry further includes a cell monitor unit (CMU) electrically connectable to one or more battery cells and configured to determine one or more parameters associated with the one or more battery cells and a power management integrated circuit (PMIC) in communication with the CMU, where one or both of the CMU and PMIC is configured to cause the SSR to perform the one or more actions based on the failure mode; and/or the MCU is in communication with the CMU and configured to determine parameter thresholds associated with the one or more parameters and transmit the parameter thresholds to the CMU; and/or the CMU is configured to determine a fault indication and transmit the fault indication to the MCU and the PMIC to cause the MCU and the PMIC to enter an active mode of operation.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a block diagram of an example battery constructed in accordance with the principles of present disclosure;

FIG. 2 shows an example system in accordance with the principles of present disclosure;

FIG. 3 is a block diagram of some entities in the system according to some embodiments of the present disclosure;

FIG. 4 shows an example battery management system according to some embodiments of the present disclosure;

FIG. 5 is an example battery management system architecture in accordance with the principles of present disclosure;

FIG. 6 shows a portion of an example BMS architecture in accordance with the principles of present disclosure;

FIG. 7 shows another portion of the example BMS architecture example BMS architecture in accordance with the principles of present disclosure; and

FIG. 8 shows an example arrangement of circuit elements in accordance with the principles of present disclosure.

### DETAILED DESCRIPTION

Before describing in detail exemplary embodiments, it is noted that the embodiments reside primarily in combinations of apparatus components and processing steps related to a battery management system such as might be used in connection with, for example, a lead acid or Li-Ion battery. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a,” “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In some embodiments, the term VSTACK is used and may refer to a voltage potential across a stack of battery cells (e.g., a plurality of battery cells such as connected in series). In some other embodiments, the term “VSTACK power unit” is used and may refer to a power unit performing one or more steps such as steps associated with the voltage potential across the stack of battery cells and/or associated with other parameters. Similarly, the term “VSTACK conditioner” may be used and may refer to an element performing one or more steps such as steps associated with conditioning of the voltage potential across the stack of battery cells and/or associated with other parameters.

In some embodiments, the term VBUS is used and may refer to a voltage potential across external battery terminals which may be isolated electrically by a relay. In some other embodiments, the term “VBUS unit” is used and may refer to a power unit performing one or more steps such as steps associated with the voltage potential across external battery terminals and/or associated with other parameters. Similarly, the term “VBUS conditioner” may be used and may refer to an element performing one or more steps such as steps associated with conditioning of the voltage potential across external battery terminals and/or associated with other parameters.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

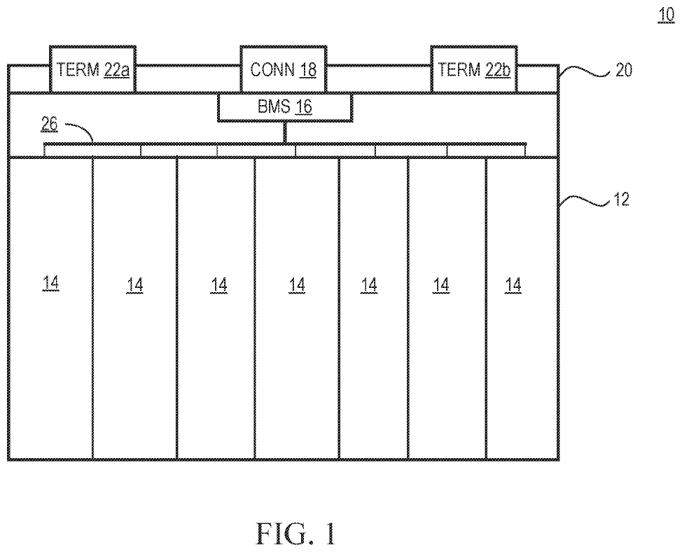

Referring now to the drawing figures in which like reference numbers refer to like elements, there is shown in FIG. 1, a battery 10 constructed in accordance with the principles of the present disclosure. Battery 10 includes a housing 12 into which one or more cells 14 are positioned. The cells 14 may be electrically interconnected (not shown in the figures), such as via an electrically conductive bus bar system which electrically interconnects the cells 14 in an electrically serial, electrically parallel or combination of electrically serial and parallel manner, depending on the intended voltage and current requirements.

A battery monitoring system (BMS) 16 may be included. In some embodiments, the BMS 16 may determine certain battery parameters, e.g., voltage, temperature, pressure, power, current, etc., and provide the data to an external system. BMS 16 may also be connected to one or more cells 14. For example, BMS 16 may be physically and/or electrically connected to a plurality of leads 26 (e.g., lead assembly), where each lead 26 is physically and/or electrically connected to a cell 14. That is, BMS 16 may be configured to determine (e.g., measure) one or more parameters of each cell 14, via a lead 26. The plurality of leads 26 may be comprised (e.g., be part of) battery 10 and/or BMS 16. Further, BMS 16 may include and/or be coupled to a monitoring connector 18 that allows for an external connection such as to the vehicle's data bus, or to some other communication device. The monitoring connector 18 can, in some embodiments, be integrated with the housing 12, such as in a cover 20 of the housing 12. Battery 10 also includes terminals, such as a negative terminal 22a and a positive terminal 22b (collectively referred to as terminals 22) to provide the contact points for electrical connection of the battery 10 to the vehicle to provide the auxiliary power to the vehicle. Terminals 22 are arranged to protrude through housing 12, such as protruding through cover 20. Terminals 22 may be electrically connected to the bus bars inside housing 12 and/or directly connected to the cells 14 (not shown in the FIGS). In some embodiments, housing 12 includes one or more vent holes 24 to allow venting from one or more of the cells 14.

Battery 10 can be arranged to provide many power capacities and physical sizes, and to operate under various parameters and parameter ranges. It is also noted that implementations of battery 10 some can be scaled to provide various capacities. Power capacity scaling can be accomplished, for example, by using higher or lower power capacity cells 14 in the housing 12, and/or by using fewer or more cells 14 in the housing 12. In some embodiments, battery 10 may be incorporated as part of a vehicle such as an electric vehicle (EV) or another type of vehicle where battery power is needed. Other electrical parameters of the battery 10 can be adjusted/accommodated by using cells 14 that may cumulatively have the desired operational characteristics, e.g., voltage, charging capacity/rate, discharge rate, etc. Thermal properties can be managed based on cell 14 characteristics, the use of heat sinks and/or thermal energy discharge plates, etc., within or external to the housing 12.

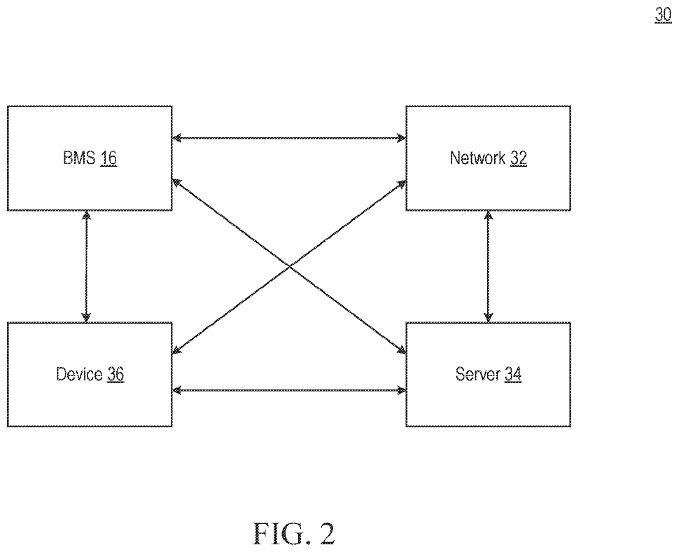

FIG. 2 shows an example system 30 in accordance with the principles of present disclosure. System 30 may include one or more of each of the following: BMS 16, network 32, server 34, device 36. In this nonlimiting example, BMS 16 may be configured to communicate with network 32 and/or server 34 and/or device 36. Network 32 may be configured to provide communication functions and/or network functions to BMS 16 and/or server 34 and/or device 36 such as access to one or more servers (e.g., server 34) and/or server functions. Server 34 may be any server, computer, client device, network node, network device, etc. Server 34 may be configured to communicate with BMS 16 and/or network 32 and/or device 36. Server 34 may be standalone, integrated with BMS 16 and/or network 32 and/or device 36, etc. Similarly, BMS 16 may be standalone, part of a device 36, part of battery 10, integrated with network 32 and/or server 34, etc. Further, BMS 16 (and/or network 32 and/or server 34 and/or device 36) may be configured to perform any of the steps and/or tasks and/or methods and/or processes and/or features described herein, e.g., such as determining one or more parameters of a battery 10 and/or performing communication functions such as transmitting/receiving one or more messages associated with one or more parameters. BMS 16 may include processing circuitry, such as a processing unit (e.g., processor) and memory, to perform one or more functions described herein. BMS 16 may include communication units (e.g., communication interfaces) to communicate with sensors that monitor the cells 14, and other operational parameters of the battery 10, and/or communicate with external elements such as network 32 and/or server 34 and/or device 36.

In particular, in addition to or instead of a processor, such as a central processing unit, and memory, the processing circuitry may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor may be configured to access (e.g., write to and/or read from) memory, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

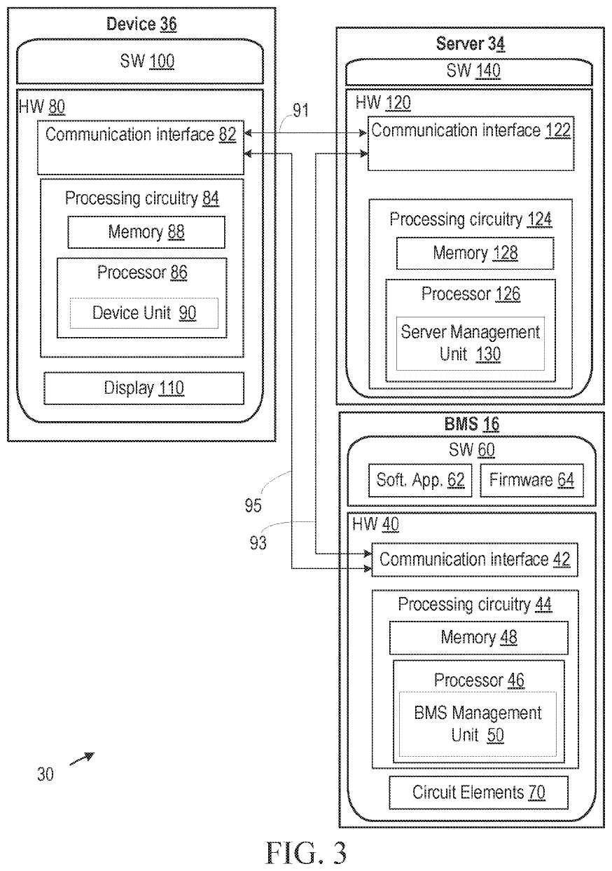

Example implementations, in accordance with an embodiment, of BMS 16, device 36, and server 34 discussed in the preceding paragraphs will now be described with reference to FIG. 3. BMS 16 may have hardware 40 that may include a communication interface 42 that is configured to communicate with one or more entities in system 30 via wired and/or wireless communication. The communication may be protocol based communications.

The hardware 40 includes processing circuitry 44. The processing circuitry 44 may include a processor 46 and memory 48. In particular, in addition to or instead of a processor, such as a central processing unit, and memory, the processing circuitry 44 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 46 may be configured to access (e.g., write to and/or read from) memory 48, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the BMS 16 may further comprise software 60, which is stored in, for example, memory 48, or stored in external memory (e.g., database, etc.) accessible by the BMS 16. The software 60 may be executable by the processing circuitry 44. Software 60 may include software application 62 and/or firmware 64.

The processing circuitry 44 may be configured to control any of the methods and/or processes described herein and/or to cause such methods, and/or processes to be performed, e.g., by BMS 16. The processor 46 corresponds to one or more processors 46 for performing BMS 16 functions described herein. The BMS 16 includes memory 48 that is configured to store data, programmatic software code and/or other information described herein. In some embodiments, the software 60 may include instructions that, when executed by the processor 46 and/or processing circuitry 44, causes the processor 46 and/or processing circuitry 44 to perform the processes described herein with respect to BMS 16. For example, the processing circuitry 44 of the BMS 16 may include BMS management unit 50 that is configured to perform any step and/or task and/or process and/or method and/or feature described in the present disclosure, e.g., determining one or more parameters, steps, and/or processes associated with battery 10. While BMS management unit 50 is illustrated as being part of BMS 16, BMS management unit 50 and associated functions described herein may be implemented in a device separate from BMS 16 such as in battery 10 or another device.

Hardware 40 may also comprise one or more circuit elements 70 such as resistors, capacitors, inductors, diodes, transistors, ground connections, source elements, sink elements, etc. Circuit elements 70 may be arranged in any configuration or connection such as series, parallel, combinations thereof, etc., and may be connected to any other device such as a component of system 30.

Device 36 may have hardware 80 that may include a communication interface 82 that is configured to communicate with one or more entities in system 30 (and/or outside of system 30) via wired and/or wireless communication. The communication may be protocol based communication. Device 36 may also be configured to electrically connect to battery 10, e.g., to device 36 (e.g., power device 36) and/or receive at least one parameter (and/or parameter data) from battery 10 and/or display the at least one parameter.

The hardware 80 includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Device 36 may further comprise software 100, which is stored in, for example, memory 88, or stored in external memory (e.g., database, etc.) accessible by the device 36. The software 100 may be executable by the processing circuitry 84.

The processing circuitry 84 may be configured to control any of the methods and/or processes described herein and/or to cause such methods, and/or processes to be performed, e.g., by device 36. The processor 86 corresponds to one or more processors 86 for performing device 36 functions described herein. The device 36 includes memory 88 that is configured to store data, programmatic software code and/or other information described herein. In some embodiments, the software 100 may include instructions that, when executed by the processor 86 and/or processing circuitry 84, causes the processor 86 and/or processing circuitry 84 to perform the processes described herein with respect to device 36. For example, the processing circuitry 84 of device 36 may include device unit 90 configured to perform any step and/or task and/or process and/or method and/or feature described in the present disclosure, e.g., determining one or more parameters, steps, and/or processes associated with battery 10. Device 36 may also include display 110 configured to display an indication associated with a measured/determined at least one parameter, e.g., associated with battery 10. The at least one parameter may include state of charge, voltage, current, etc. Display 110 may comprise a light such as a light emitting diode (LED), a monitor, a screen, and/or any other type of display.

In some embodiments, device 36 and/or any of its components such as display 110 may be comprised in BMS 16 (and/or battery 10) and/or be powered by BMS 16 (and/or battery 10).

Further, server 34 includes hardware 120, and the hardware 120 may include a communication interface 122 for performing wired and/or wireless communication with BMS 16 and/or device 36 and/or any other device. For example, communication interface 122 of server 34 may communicate with communication interface 82 of device 36 via communication link 91. In addition, communication interface 122 of server 34 may communicate with communication interface 42 of BMS 16 via communication link 93. Similarly, communication interface 42 may communicate with communication interface 82 via communication link 95. At least one of communication links 91, 93, 95 may refer to a wired/wireless connection (such as WiFi, Bluetooth, etc.).

In the embodiment shown, the hardware 120 of server 34 includes processing circuitry 124. The processing circuitry 124 may include a processor 126 and a memory 128. In particular, in addition to or instead of a processor, such as a central processing unit, and memory, the processing circuitry 124 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 126 may be configured to access (e.g., write to and/or read from) the memory 128, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the server 34 further has software 140 stored internally in, for example, memory 128, or stored in external memory (e.g., database, etc.) accessible by the server 34 via an external connection. The software 140 may be executable by the processing circuitry 124. The processing circuitry 124 may be configured to control any of the methods and/or processes described herein and/or to cause such methods, and/or processes to be performed, e.g., by server 34. Processor 126 corresponds to one or more processors 126 for performing server 34 functions described herein. The memory 128 is configured to store data, programmatic software code and/or other information described herein. In some embodiments, the software 140 may include instructions that, when executed by the processor 126 and/or processing circuitry 124, causes the processor 126 and/or processing circuitry 124 to perform the processes described herein with respect to server 34. For example, processing circuitry 124 of server 34 may include server management unit 130 that is configured to perform one or more server 34 functions as described herein, e.g., determining one or more parameters, steps, and/or processes associated with battery 10.

In some embodiments, device 36 may be comprised in a BMS 16 and/or battery 10 (as shown in FIG. 1) and/or be standalone. In some other embodiments, device 36 may be configured to perform any BMS function. In some embodiments, device 36 and battery 10 are comprised in a vehicle, and device 36 may be connectable to battery 10 and/or BMS 16.

Although FIG. 3 shows one or more “units” such as BMS management unit 50, device unit 90, server management unit 130 as being within a respective processor, it is contemplated that these units may be implemented such that a portion of the unit is stored in a corresponding memory within the processing circuitry. In other words, the units may be implemented in hardware, software or in a combination of hardware and software within the processing circuitry.

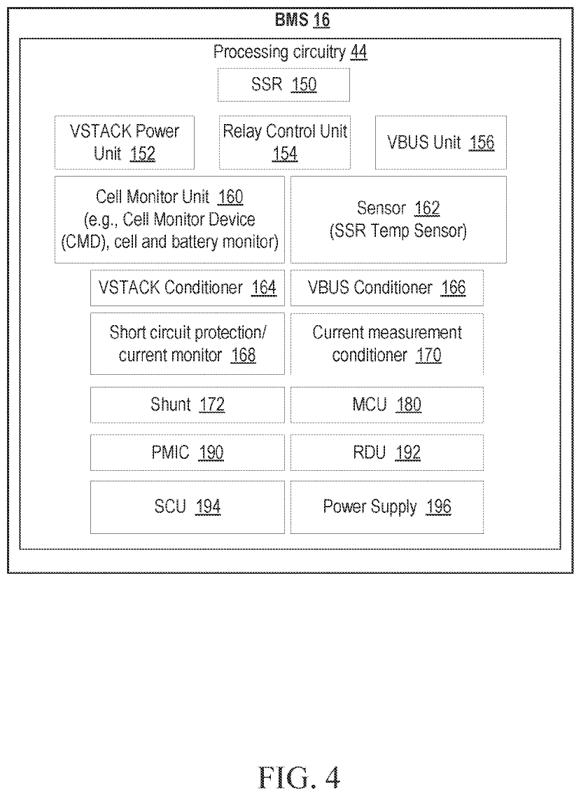

FIG. 4 shows an example BMS 16. BMS 16 may comprise one or more components, which can be in addition to the components of BMS 16 described with respect to FIG. 3. BMS 16 may comprise a solid state relay (SSR) 150 (which may be a circuit element 70 and/or may be referred to as relay 150), a VSTACK Power unit 152, a relay control unit (RCU) 154, a VBUS unit 156, a cell monitor unit (CMU) 160, sensor 162 (e.g., such as a temperature sensor), VSTACK conditioner 164, VBUS conditioner 166, short circuit protection/current monitor 168, current measurement conditioner (CMC) 170, a shunt 172, microcontroller (MCU) 180, a power management (and/or control) integrated circuit (PMIC) 190, relay driver unit (RDU) 192, a secondary current unit (SCU) 194, and a power supply (PS) 196. SSR 150 may be configured as a switch to open and close an electrical connection such as from a positive cell terminal to a battery terminal. SSR 150 may be arranged to receive a signal that triggers SSR 150 to open or close. In some embodiments, SSR 150 may refer to more than one SSR such as a primary SSR and a secondary SSR. VSTACK power unit 152 may be configured to perform one or more steps associated with one or more parameters such as voltage (e.g., of a battery stack). RCU 154 may be configured to perform relay control functions such as receiving diagnosis signaling from MCU 180, PMIC 190, supply voltage, etc. VBUS power unit may be configured to perform one or more steps associated with one or more parameters such as voltage (e.g., of a battery bus).

Further, CMU 160 may be configured to perform monitoring functions such as a cell monitor device (CMD), cell and battery monitor, etc. In some embodiments, the CMU 160 (and/or other BMS components) may be configured to monitor and control SSR 150 (and/or any other BMS components without MCU 180 intervention (i.e., without the MCU 180 performing any action associated with the SSR 150). Sensor 162 may be any sensor such as temperature sensor. VSTACK conditioner 164 may be configured to provide electric conditioning of signals, e.g., associated with a battery stack. Similarly, VBUS conditioner 166 may be configured to provide electric conditioning of signals, e.g., associated with a battery bus. Short circuit protection/current monitor may be configured to monitor electric circuit conditions and/or parameters such as short-circuit conditions, electric current values, etc. and perform one or more actions to protect the electric circuit. Current measurement conditioner 170 may be configured to perform conditioning functions associated with measurements of any parameters such as current. Shunt 172 may be arranged to provide path (e.g., having a predetermined resistance such as a low-resistance) for an electrical current, which may allow the current to flow to an alternative point in the electric circuit.

MCU 180 may be configured to provide monitoring functions such as primary monitoring, monitor a vehicle interface, secondary VSTACK, current and VBUS measurements, etc. PMIC 190 is configured to provide supply voltage, receive fault indications, transmit SSR control signals, and provide power supply and watchdog process features. RDU 192 may be configured to provide relay driver features. In some embodiments, RDU 192 is comprised in RCU 154 (i.e., RCU 154 is configured to perform one or more functions associated with RDU 192). SCU 194 may be configured to perform conditioning functions such as to conditioning current. Power supply (PS) 196 may be arranged to provide power to one or more elements. In some embodiments, PMIC 190 may comprise PS 196 and/or perform one or more functions associated with PS 196. In some other embodiments, PMIC 190 may be a PS 196 of the BMS 16 and may be configured to power (and interface with) other BMS components such as MCU 180, e.g., to perform safety supervisory functions. Any of the components of BMS 16 may be configured to receive one or more inputs (e.g., input signals), perform one or more actions/determinations, and generate one or more outputs (e.g., output signals).

In some embodiments, one or more of the components shown in FIG. 4 are comprised in and/or be part of battery management unit 50 and/or circuit elements 70.

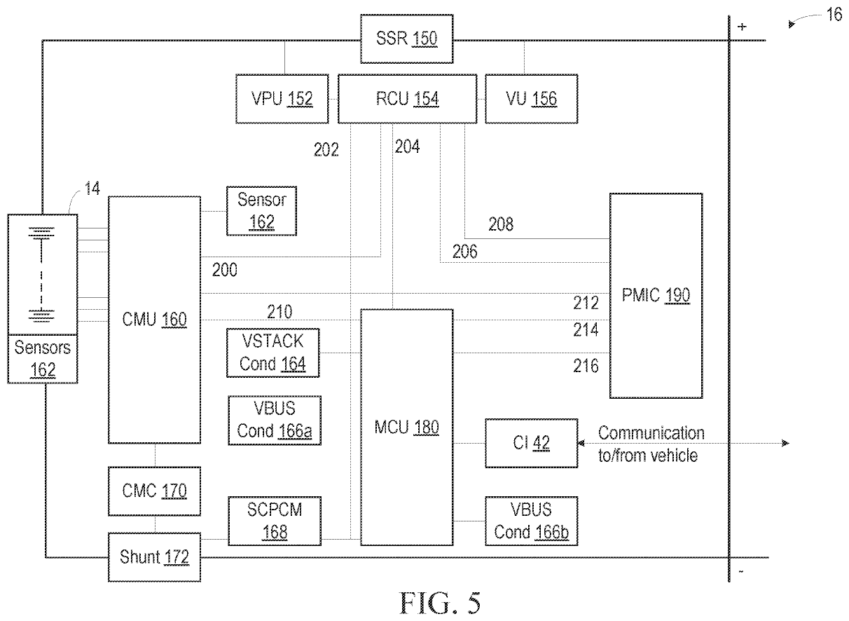

FIG. 5 shows an example battery management system (BMS) architecture according to the principles of the present disclosure. The example battery management system architecture may be that of an electronics 12V auxiliary BMS architecture. BMS 16 may include a battery management unit (BMU) 50. In some embodiments, BMS refers to BMU, i.e., the two terms may be used interchangeably.

It is noted that, although FIG. 5 shows a BMS block diagram with four cells, these details are provided solely to aid understanding and are not intended to limit implementations. It is contemplated that the concepts/arrangements shown and described herein can be adapted for use with more or fewer than four cells 14. Embodiments of BMS 16 can be implemented in 12 Volt systems as well as systems that are based on other than 12 Volts.

BMS 16 may include one or more logic components, actuate components, and sense components. The logic components may include at least one of: MCU 180 which may be configured as a primary monitor, vehicle interface, secondary VSTACK, current and VBUS measurements; a communication interface (CI) 42 comprising a transceiver such as a controller area network (CAN) FD transceiver which may be configured to communicate with the MCU 180 and/or a vehicle, e.g., using CAN FD; and a PMIC 190 which may be configured to be a power supply and watchdog timer. The actuate components may include at least one of a power component such as VSTACK Power unit 152, RCU 154, a VBUS Unit (VU) 156, and/or a relay such as an SSR 150. The sense components may include at least one sensor 162 such as an SSR temperature sensor, VSTACK conditioner 164, VBUS conditioner 166, short circuit protection and/or current monitor 168, current measurement conditioner 170, a shunt 172, and/or a CMU 160 (e.g., cell and battery monitor).

CMU 160 may be configured to provide at least one of the following: cell monitoring, cell balancing, primary VSTACK measurement, shunt current monitor, primary VBUS monitor, safety monitoring, temperature sensor readings, and/or any other type of monitoring/sensing/management functions associated with battery 10 (and/or its components) and/or a vehicle. CMU 160 may further be configured to electrically connect to one or more cells 14 (e.g., via leads 26), and/or any other battery/vehicle component (e.g., via one or more leads) and/or measure/manage/monitor/control any battery/cell parameter such as temperature, voltage, current, pressure, etc. Although some connections are shown between some components, any component such as a logic component, an actuate component, and a sense component may be connected (e.g., electrically connected and/or in communication with) any other component. Any one of the components shown may transmit and/or receive one or more signals (e.g., control signals, indications, information, etc.).

In a nonlimiting example, CMU 160 may be configured to receive, via connection 200, SSR current feedback. RCU 154 may be connected to SCPCM 168, via connection 202, such as for monitoring and protection of the RCU. RCU 154 may provide/receive SSR diagnostics, via connection 204, receive SSR control, via connection 206, and supply voltage, via connection 208. In addition, CMU 160 may transmit/receive data and/or signals, via connection 210 (i.e., via a serial peripheral interface (SPI)) to/from MCU 180 and provide fault information to PMIC 190, via connection 212. MCU 180 may exchange discrete faults with PMIC 190, via connection 214. MCU 180 may also exchange SPI with PMIC 190, via connection 216. SPI may refer to an industry standard interface which may be used between components such as integrated circuits (ICs). Further, the SPI may be configured as an interface to communicate between ICs using a plurality of wires or conductors. For example, the SPI may be a 4-wire interface.

In some embodiments, the example BMS architecture of FIG. 5 may include one or more of the following features/options:
Integrated BMS (single printed circuit board assembly (PCBA)).
Flexible, wired, direct mount cell voltage and temperature connections.
Power Architecture:
   Powered by internal 12V Li-Ion battery.
   Common 12V ground at battery terminal.
Battery Disconnect:
   Solid State Relay (SSR) (e.g., metal-oxide-semiconductor field-effect transistor (MOSFET).
   Bi-stable electro-mechanical.
   Mono-stable electro-mechanical.
Integrated shunt current measurement:
   Lower system integration cost.
   High signal noise immunity.
Functional safety strategy according to International Organization for Standardization (ISO) 26262:
   Supports Automotive Safety Integrity Level (ASIL) C/D.
   Dual monitor & single micro with ext. watchdog solutions.
AUTomotive Open System Architecture (AUTOSAR).
Cyber security.
Over the air (OTA) communication, e.g., for performing OTA programming of BMS 16 and/or any of its components such as MCU 180.

In one or more embodiments, operation deployment associated with a BMS 16 is provided. The BMS 16 may be included and/or be part of a battery 10. In some embodiments, the example operation deployment is associated with the BMS 16 shown in FIG. 5. In some other embodiments, the example operation deployment may refer to software and/or hardware of BMS 16. In some embodiments, the example operation deployment refers to BMS 16 (and/or BMU). BMS 16 may include processing circuitry, which may include a processor, memory, a communication interface, and/or software such as an operating system (OS). More specifically, in this example operation deployment at least one of the following, which may reside in software and/or hardware, is included: a microcontroller (e.g., processor, processing circuitry), software 60 (e.g., a battery software (BSW) such as firmware 64), an RTE, a boot loader, and an application such as software application 62.

In some embodiments, one or more components (e.g., battery, hardware, etc.) shown in FIG. 5 may be combined (e.g., integrated with) with any other components, e.g., to provide management functions such as battery management functions of battery 10. In a nonlimiting example, components may be used to provide/determine a state of charge, function, health of the battery and/or provide diagnostics and/or management/control functions. The cells shown in FIGS. 1 and 5 may be managed (e.g., by CMU 160 of FIG. 5 and/or any other microcontroller) and/or controlled.

In another nonlimiting example, when a battery/cell parameter (e.g., measured by any sense component) is lower than a predetermined threshold and/or equals a predetermined state (e.g., determined by any component of system 30 such as BMS 16), solid state relay (SSR) 150 may close (e.g., triggered by an input to the relay from a sense component or a logic component), thereby allowing cells 14 and battery 10 to provide power on the positive terminal. Similarly, when a battery/cell parameter (e.g., measured by any sense component) is greater than a predetermined threshold and/or does not equal a predetermined state (e.g., determined by any component of system 30 such as BMS 16), SSR 150 may open (e.g., triggered by an input to the relay from a sense component or a logic component), thereby cutting the power on the positive terminal. Further, any state, diagnostic, parameter, determination, information, etc., may be communicated to another component (software and/or hardware) such as via a CAN FD transceiver of communication interface 42.

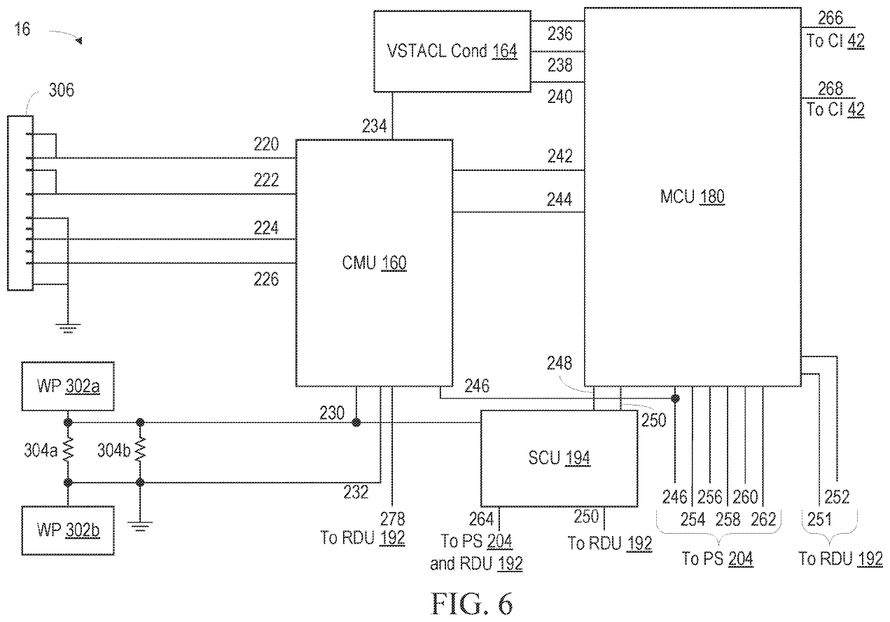

FIG. 6 shows a portion of an example BMS architecture. CMU 160 may be configured to determine one or more parameters of cells 14 such as via at least one connection 220 with battery interface 306 which may be comprised in or be part of leads 26. In some embodiments, CMU 160 is arranged to measure, via connection 222, cell parameters of five cells (e.g., CELLS0, CELLS1, CELLS2, CELLS3, CELLS4) and another parameter such voltage (e.g., CELL_VDD). Further, CMU 160 may be configured to measure, via connections 224, 226, temperature of the cells 14 (via sensors 162). Connections 224, 226 may refer to temperature connection return (e.g., TMEP1_RET), and temperature (e.g., TEMP1). CMU 160 may be further configured to determine current of a pack such as negative current, via connection 230, and positive current, via connection 232. Connections 230, 232 may be referred to as IPAC_NEG and IPACK_POS. Resistors 304a, 304b (i.e., circuit elements 70) may be connected in parallel to a welding pads 302a, 302b, and grounded to a ground connection. CMU 160 may further provide or exchange with VSTACK conditioner 164, via connection 234, signaling associated with cell monitoring such as voltage of a bus (i.e., VBUS_CMD). VSTACK conditioner 164 may be connected to and or provide a bus voltage (i.e., VBUS connection). VSTACK conditioner 164 may also exchange signaling with MCU 180 such as signal that enables one or more measurements (VBUS_CMD_MEAS_EN via connection 236, VBUS_MCU_MEAS_EN via connection 238) and/or other signaling (e.g., VBUS_MCU via connection 240). CMU 160 and MCU 180 may exchange reset signals such as via connection 242, SPI via connection 244 (i.e., CMD_SPI). In addition, CMU 160 may be configured to transmit/receive fault indications via connection 246 (i.e., CMD_FLT).

MCU 180 may also receive/transmit test signaling (i.e., TEST_SC) via connection 248, which may be transmitted/received by SCU 194. Further, secondary current (and/or secondary current value) may be exchanged between SCU 194 and MCU 180 via connection 250. Further, MCU 180 may exchange SSR signaling such as control and fault information with RDU 192, via connections 251, 252, respectively. Further, faults can be transmitted/received by MCU 180, via connection 254 to PS 196. Other signals may be exchanged between MCU 180 and PS 196 such as PS_SPI, MCU reset, analog power supply signals, PMIC-MCU related signals, via connections 256, 258, 260, 262. SCU 194 may also transmit/receive signals associated with power via connection 264 to RDU 192. In some embodiments, RDU 192 may be part of RCU 154. Further, MCU 180 may exchange CAN and LIN data/information with communication interface (CI) 42, via connections 266, 268. CMU 160 may also exchange SSR-related signaling with RDU 192, via connection 278.

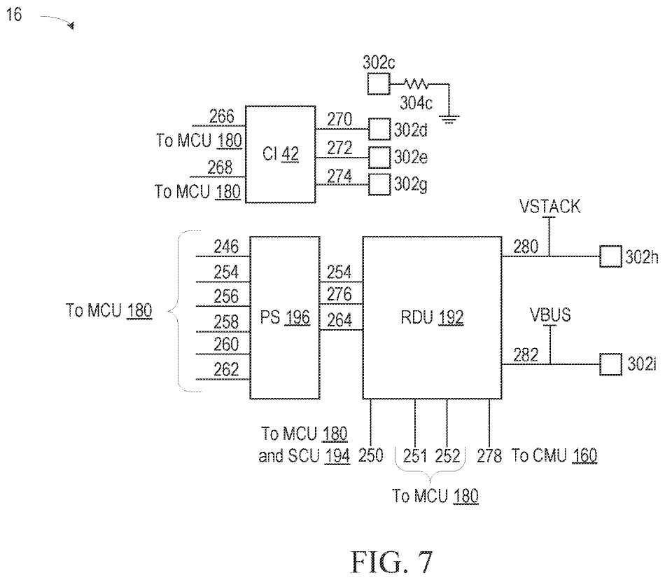

FIG. 7 shows another portion of the example BMS architecture of FIG. 6. CI 42, PS 196, and RDU 192 are shown, any of which may be connected to any component of the components shown in FIG. 6. For example, CI 42 may be connected to (and/or receive/transmit signals) MCU 180 using connections 266, 268, as described in the present disclosure. PS 196 may be connected to MCU 180 using connections 246, 254, 256, 258, 260, 260, as described in the present disclosure. Further, RDU 192 may be connected to MCU 180 and SCU 194 via connection 250, to MCU 180 via connections 251, 252 and to CMU 160 via connection 278. Further, PS 196 may be connected to RDU 192 via connections 254, 276, 264 for exchange of faults, voltage (i.e., V_RVP), and SSR signals (i.e., SSR_GD_EN), respectively.

CI 42 may transmit/receive indications associated with a protocol such as CAN/LIN, i.e., CANH_FD, CANIL_FD, LIN_BUS, via connections 270, 272, 274 and well pads 302d, 302e, 302g. Well pad 302c may be grounded via resistor 304c. In addition, RDU 192 may be connected to (via connection 280) and/or receive and/or transmit VSTACK (i.e., stack voltage), in addition to well pad 302h. Similarly, RDU 192 may be connected to (via connection 282) and/or receive and/or transmit VBUS (i.e., bus voltage), in addition to well pad 302i.

Some embodiments provide protection of battery 10 and associated vehicle. CMU 160 (e.g., CMD) may be used with PMIC 190 such as to provide protection associated with functional safety (FuSa) requirements directed to vehicles is in a predetermined connected mode (i.e., off).

BMS 16 (e.g., CMU 160 and/or PMIC 190) may be configured to disable SSR 150 without MCU intervention such as when the MCU 180 does not wake up or has some failure mode. Disabling SSR 150 as such provides a high Automotive Safety Integrity Level (ASIL). Additionally, BMS 16 may be configured to detect a short-circuit (SC) such as while a system component (and/or vehicle) is in a sleep mode and open the SSR 150 such as to provide a functional safety action. In some embodiments, SC protection—low Iq (i.e., low quiescent current) fast acting is provided, where SC detection and protection may be provided without MCU intervention for sleep state protection. The low Iq fast acting, short circuit detection and protection without MCU intervention for sleep state protection may detect the short circuit event and open the relay directly without MCU intervention.

In some other embodiments, the battery 10 and vehicle may be protected from conditions that may exist when the vehicle is off and vehicle controls are asleep with the battery providing power to the off state loads of the vehicle. The battery 10 can be protected against abuse conditions such as short circuit, overcharging of the battery, or other possible battery/cell faults like over temperature when the MCU 180 is asleep or unable to wake up from sleep to provide the intelligent protection.

In some embodiments, CMU 160 detects cell voltage and temperature. Overvoltage and overtemperature limits may be set by the MCU 180 via the SPI. CMU 160 may have a fault line (i.e., connection 246, CMD_FLT) that wakes up the MCU 180 and the PMIC 190. If the MCU 180 does not take action within a specified period of time, the PMIC 190 may detect and disable the SSR 150 and/or open the SSR 150. The PMIC 190 detects the MCU's fault through an intelligent watchdog that monitors the MCU function.

In some other embodiments, SCU 194 (e.g., secondary current block) is configured to detect over current or short circuit based on a preset hardware current threshold. In the event of a hard short circuit, the RDU 192 (e.g., relay driver) detects and opens up the SSR to protect the battery 10 and BMS 16. If there is a resistive short, then the MCU 180 may have time to wake up and provide the proper protection.

Conventional solutions do not allow power availability to the vehicle or have secondary MCUs 180 or logic devices to handle the faults or abuse conditions if the main MCU 180 does not respond.

In some embodiments, SSR 150 is arranged to be scalable for low current to high current. Various MOSFET pairs may be used to provide a wide range of scales to manage current pulses and the power dissipation associated with those. In some other embodiments, one or more pairs of MOSFETs (e.g., five pairs) meet 12V Aux requirements such as 200 A for 300 s. In some embodiments, the size of a heatsink may have an impact on total power that can be dissipated.

In some other embodiments, BMS 16 includes one or more shunts (e.g., a pair of 200 u Ohm shunts in parallel such as resistors 304a, 304b. The collective resistance and power rating of the shunts allows operation to the maximum current range defined with a predetermined margin. One of those shunts may be depopulated for lower current applications.

In some embodiments, with respect to FuSa, the BMS architecture may include CMU 160, MCU 180, and PMIC 190 that can achieve from ASIL QM—ASIL D based on the diagnostic coverage implemented within the software design and software development practices utilized. The BMS 16 can operate the battery 10 in a safe state with or without intervention from the MCU 180 and in operating or sleep state. The CMU 160 design along with the PMIC 190 provides the redundancies to achieve the FuSa requirements and are scalable for lower or higher ASIL capabilities beyond the current 12V Aux target. The PMIC 190 is arranged to provide various levels of watchdog functionality to ensure the operation of the MCU 180.

In some other embodiments, MCU 180 provides memory (e.g., a portion of memory 48 such as nonvolatile memory such as flash and random access memory (RAM)) for the software 60 to implement an AUTOSAR operating system. MCU 180 allows running during reprogramming supporting over the air (OTA) updates. Further, memory associated with MCU 180 may be variable.

In some embodiments, CMU 160 (e.g., cell monitor device (CMD)) may be configured to provide cell and battery monitoring functions and may be scalable to accommodate different quantities of cells 14 (such as 4, 6, 14 cell device) with the same software interfaces. CMU 160 can also accommodate different levels of balancing current (e.g., up to 300 mA total per device). In some other embodiments, PMIC 190 is scalable based on the level of safety. PMIC 190 may also be power scalable. In some embodiments, communication interface 42 may include a CAN transceiver configured to provide high-speed CAN (HS CAN) and CAN Flexible Data-Rate (CAN FD) capability.

Some embodiments provide solutions to problems in known technology with respect to the ability to diagnose SSR for functional safety reasons. SSR diagnostics may include ensuring whether the SSR can be triggered to open and close (e.g., without being able to open and close the SSR). Additionally, to meet battery current requirements, the SSR typically requires electrically parallel configurations of MOSFETs to handle the current. However, it may be challenging to determine whether there is a MOSFET that is stuck open when there are many MOSFETs in parallel. Further, if undiagnosed, the other MOSFETs may overheat. Additionally, some arrangements include two MOSFETs in series to handle bi-directional current blocking, thereby demanding that both of the series MOSFETs to be diagnosable to ensure proper charge and discharge blocking.

One or more embodiments of the present disclosure provide performing the diagnostics (e.g., of BMS relays such as SSRs) while having the battery 10 connected to a vehicle bus. In some embodiments, any open or shorted MOSFET or MOSFET pair may be detected. In some embodiments, an arrangement of circuit elements 70 includes a secondary low current MOSFET SSR that can supply power while the main SSR can be diagnosed. The arrangement may additionally provide the ability (e.g., via software control) to individually measure a parameter before and after common drain point(s) and determine whether there is a stuck open or stuck closed MOSFET. In some other embodiments, the arrangement is usable to determine whether any MOSFET is open.

In some embodiments, a secondary SSR using p-channel devices is used. The drain connections between MOSFET pairs may be separated, and measurements of each drain voltage taken. Independent charge and discharge control may be provided, e.g., so each MOSFET can be diagnosed. One or more states may be diagnosed, via software/hardware elements, e.g., by performing one or more steps associated with the measurement and control process.

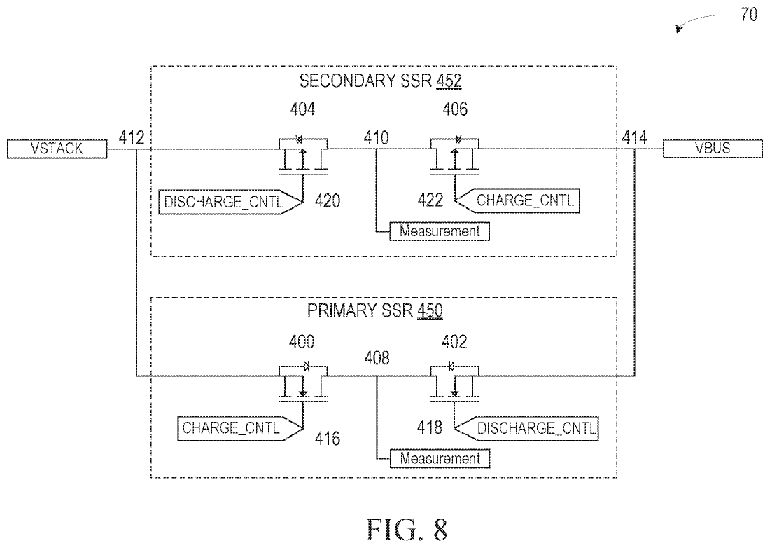

FIG. 8 shows an example arrangement of circuit elements 70, which may be part of SSR 150 (and/or RCU 154 and/or RDU 192) and/or any other component of BMS 16. In a nonlimiting example, four transistors 400, 402, 404, 406 are shown. The transistors may be metal-oxide-semiconductor field-effect transistors (MOSFETs). Transistors 400, 404 may be connected to the VSTACK on one side (i.e., at connection point 412) and to transistors 402, 406, respectively, on another side. Further, transistors 402, 406 may be connected to VBUS (i.e., at connection point 414). Measurement points 408, 410 can be provided and connected to BMS 16 such as to measure a parameter (e.g., voltage) associated with transistors 400, 402, 404, 406 and/or VSTACK and/or VBUS. For example, voltage across measurement points 408, 410 may be measured. In another example, voltage across measurement point 408 (or measurement point 410) and another point may be measured. In some embodiments, a transistor state (e.g., open, closed) may be determined based on a change in voltage measured at measurement points 408, 410. In some other embodiments, each of the common drain points (i.e., measurement points 408, 410) measured before and after each charge and discharge control states are used to determine whether the MOSFETS (i.e., transistors 400, 402, 404, 406) are operational.

Further, each transistor has a control point (e.g., gate). For example, transistor 400 may have control point 416, transistor 402 may have control point 418, transistor 404 may have control point 420, and transistor 406 may have control point 422. Each control point (e.g., gate) may be configured to control current flow between the drain and source of the transistor. For example, voltage may be applied to the control point, which may create an electrical field that controls the current flow through the channel between the drain and source. In one or more embodiments, charge control (i.e., CHARGE_CNTL) refers to energizing a corresponding transistor that would allow battery 10 to be charged, e.g., turning one or both of transistors 400, 406. In other words, control points 416, 422 may be enabled or energized which makes transistor 400, 406 usable for charging battery 10. In some other embodiments, discharge control (i.e., DISCHARGE_CNTL) refers to energizing a corresponding transistor that would allow battery 10 to be discharged. That is, control points 418, 420 may be enabled or energized which makes the corresponding transistor usable for discharging battery 10. However, the embodiments of the present disclosure are not limited as such and any one of control points 416, 418, 420, 422 may be energized for charging, discharging, or any other function.

In some embodiments, transistors 402, 402 may be referred to as a primary SSR 450, and transistors 404, 406 may be referred to as a secondary SSR 452. In some other embodiments, any component of FIG. 8 (e.g., transistors, SSRs) may be connected to other elements (e.g., in parallel) such as to increase current passing capabilities. In some embodiments, one or more diagnostics (e.g., diagnostic of primary, secondary SSRs 450, 452) may be performed using the example arrangement. For example, one or more of the following steps may be performed (e.g., by BMS 16):
Perform secondary SSR diagnostics prior to testing a primary SSR 450;
Perform the diagnostic when vehicle associated with battery 10 is asleep and at low current (i.e., in predetermined mode);
Verify the secondary SSR 452 is not stuck on (i.e., closed) such as by reading common drain voltage;
Verify the secondary SSR 452 is not stuck open by (e.g., independently) enabling and disabling both the stack and bus side of the secondary SSR 452 and by reading the common drain voltage;
With the primary SSR 450 enabled, measure the common drain voltage;
Disable the primary SSR 450 and measure the common drain voltage to determine if any MOSFET pair is stuck on or shorted;
Enable the charge MOSFETs and measure the common drain measurements to verify if any are stuck open;
Disable the charge MOSFETs; and. Enable the discharge MOSFETs and measure the common drain measurements to verify if any are stuck open.

One or more embodiments are beneficial at least because the example arrangement provides one or more of:
A low current secondary SSR 452;
Each primary MOSFET pair includes an isolated common drain from other parallel pairs;
The primary and secondary SSR paths are diagnosable;
Each MOSFET pair can be diagnosed for stuck on or short circuit;
Each MOSFET can be diagnosed for stuck open or open circuit;
Scalable design;
Functional Safety (FuSa) architecture vehicle off relay closed;
Solid state relay protection and diagnostic design; and
BMU/BMS fail safe design for connected vehicle off mode.

It is understood that all specification values shown and described herein are non-limiting examples for implementations of batteries 10, cells 14, BMS 16 (and/or BMU) constructed in accordance with the principles of the disclosure provided herein. It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A relay of a battery management system, BMS, the relay comprising:
a bus connection point;
a stack connection point;
a primary solid state relay, SSR, electrically connected to the bus connection point and the stack connection point, the primary SSR comprising:
a first measurement point usable by the BMS for determining a first SSR state; and
a secondary SSR electrically connected to the bus connection point and the stack connection point, the secondary SSR being connected in parallel to the primary SSR and comprising:
a second measurement point usable by the BMS for determining a second SSR state.

2. The relay of claim 1, wherein the primary SSR comprises:
a first transistor having a first source and a first drain; and
a second transistor having a second source and a second drain, the second transistor being connected in series to the first transistor, the first drain being electrically connected to the second drain, the first source being electrically connected to the stack connection point, the second source being electrically connected to the bus connection point.

3. The relay of claim 2, wherein one or more of:
the first measurement point is positioned between the first drain and the second drain;
the first transistor comprises a first control point arranged to receive a first control signal that triggers the first transistor to open or close; and
the second transistor comprises a second control point arranged to receive a second control signal that triggers the second transistor to open or close.

4. The relay of claim 1, wherein the secondary SSR comprises:
a third transistor having a third source and a third drain; and
a fourth transistor having a fourth source and a fourth drain, the fourth transistor being connected in series to the third transistor, the third drain being electrically connected to the fourth drain, the third source being electrically connected to the stack connection point, the fourth source being electrically connected to the bus connection point.

5. The relay of claim 4, wherein one or more of:
the second measurement point is positioned between the third drain and the fourth drain;
the third transistor comprises a third control point arranged to receive a third control signal that triggers the third transistor to open or close; and
the fourth transistor comprises a fourth control point arranged to receive a fourth control signal that triggers the fourth transistor to open or close.

6. The relay of claim 1, wherein the secondary SSR is arranged to supply power while the primary SSR is one of diagnosed and open.

7. The relay of claim 1, wherein the primary SSR is a first metal oxide-semiconductor field-effect transistor, MOSFET, SSR and the secondary SSR is a second MOSFET SSR.

8. A battery management system, BMS, comprising:
a solid state relay, SSR; and
processing circuitry comprising a microcontroller unit, MCU, the processing circuitry being electrically connected to the SSR and configured to:
determine a failure mode associated with the MCU based on one or more parameters; and
cause the SSR, without MCU intervention, to perform one or more actions based on the failure mode.

9. The BMS of claim 8, wherein the processing circuitry further comprises:
a cell monitor unit, CMU, electrically connectable to one or more battery cells; and
a power management integrated circuit, PMIC, in communication with the CMU, one or both of the CMU and PMIC being configured to cause the SSR to perform the one or more actions based on the failure mode.

10. The BMS of claim 9, wherein the CMU is configured to determine one or more parameters associated with the one or more battery cells.

11. The BMS of claim 10, wherein the MCU is in communication with the CMU, and the MCU is configured to determine parameter thresholds associated with the one or more parameters and transmit the parameter thresholds to the CMU.

12. The BMS of claim 9, wherein the CMU is configured to determine a fault indication and transmit the fault indication to the MCU and the PMIC to cause the MCU and the PMIC to enter an active mode of operation.

13. The BMS of claim 9, wherein the PMIC is configured to determine the failure mode associated with the MCU based on a watchdog process usable for monitoring one or more MCU processes.

14. The BMS of claim 8, wherein the processing circuitry further comprises a secondary current unit, SCU, configured to detect an overcurrent condition based on a predetermined hardware current threshold.

15. The BMS of claim 14, wherein the SCU is further configured to cause the SSR to perform one or more actions based on the detected overcurrent condition and the predetermined hardware current threshold.

16. The BMS of claim 8, wherein the SSR comprises:
a bus connection point;
a stack connection point; and
a primary solid state relay, SSR, electrically connected to the bus connection point and the stack connection point, the primary SSR comprising:
a first measurement point usable by the BMS for determining a first SSR state.

17. The BMS of claim 16, wherein the SSR further comprises:
a secondary SSR electrically connected to the bus connection point and the stack connection point, the secondary SSR being connected in parallel to the primary SSR and comprising:
a second measurement point usable by the BMS for determining a second SSR state.

18. The BMS of claim 8, wherein the one or more actions include one of disabling the SSR, enabling the SSR, opening the SSR, and closing the SSR.

19. A battery comprising:
one or more battery cells;
a battery management system, BMS, electrically connected to the one or more battery cells, the BMS comprising:
a solid state relay, SSR, electrically connected to the one or more battery cells;
processing circuitry comprising a microcontroller unit, MCU, the processing circuitry being electrically connected to the SSR and configured to:
determine a failure mode associated with the MCU based on one or more parameters; and
cause the SSR, without MCU intervention, to perform one or more actions based on the failure mode.

20. The battery of claim 19, wherein one or more of:
the processing circuitry further comprises:
a cell monitor unit, CMU, electrically connectable to one or more battery cells and configured to determine one or more parameters associated with the one or more battery cells; and
a power management integrated circuit, PMIC, in communication with the CMU, one or both of the CMU and PMIC being configured to cause the SSR to perform the one or more actions based on the failure mode;
the MCU is in communication with the CMU and configured to determine parameter thresholds associated with the one or more parameters and transmit the parameter thresholds to the CMU; and
the CMU is configured to determine a fault indication and transmit the fault indication to the MCU and the PMIC to cause the MCU and the PMIC to enter an active mode of operation.
